(19) United States
(12) Patent Application Publication
(10) Pub. No.: US 2017/0193621 A1
(43) Pub. Date: Jul. 6, 2017

(54) Online Computerized Platform/Clearinghouse for Providing Rating, Ranking, Recognition, and Comparinf of Students

(71) Applicant: STEM Premier, Inc., Mount Pleasant, SC (US)

(72) Inventors: Casey L. Welch, Mount Pleasant, SC (US); Donald J. Tylinski, Mount Pleasant, SC (US); John W. Welch, Ford City, PA (US)

(21) Appl. No.: 13/999,543

(22) Filed: Mar. 8, 2014

Related U.S. Application Data
(60) Provisional application No. 61/851,679, filed on Mar. 11, 2013.

(51) Int. Cl. G06Q 50/20; G06Q 10/10

(52) U.S. Cl. CPC G06Q 50/2053; G06Q 10/10

(57) ABSTRACT

An online computerized system processes related methods to create of a electronic global data base platform for the rating, ranking, comparing and/or recognition of students in the science, technology, engineering, and math (STEM) field. The methods employed include the accumulation, analysis, utilization, and publication of both public and student derived information related to rating, ranking, tracking, identification, and recognition of students. Students are rated and ranked against other students utilizing both public information and student-derived information. The system provides an online platform for students to be globally recognized, a database of STEM talent, and a platform where students can actively compete with other students to achieve high ratings and improve their ratings. The system can be utilized as a STEM clearinghouse and/or market exchange that identifies qualified individual students and market participants.

### RELATED APPLICATIONS

The present patent application claims priority to the previously filed and presently pending provisional patent application filed on Mar. 11, 2013, and assigned patent application No. 61/851,679.

### BACKGROUND

In the realm of college athletics, as athletes compete with each other for playing time, scholarships and the right to be recruited, they have intermediaries to rate and rank them through several nationally recognized systems. Through a myriad of skill abilities and competitions, athletes are rated and ranked nationally. Student athletes currently have platforms which enable them to been seen, compared to like athletes, and receive recognition through many different outlets, such as online media platforms, publications, and national recruiting services, which can lead to future opportunities to extend their athletic careers.

By comparison, academically oriented students can be seen as academic stars similar to athletes, and they ultimately may be of greater significance to society than athletes are. Top academic students are normally ranked based on their grade point averages in their own schools, but are not compared to students in other schools nationally except by scores on standardized tests. Top academic students at the upper levels in their schools do not have an intermediary method to efficiently and accurately identify them as top students nationally and globally.

### SUMMARY

An example method includes receiving, by a processor, data regarding a student user, including a number of performance indicators. The example method includes generating, by the processor, a score for the student user based on the performance indicators. The example method includes comparing, by the processor, the score for the student user to publicly available data. The example method includes determining, by the processor, a rating value for the student user based on the score for the student user as compared to the public data. The example method includes outputting, by the processor, the rating value.

Another example method includes receiving, by a processor, information from a student user. The example method includes storing, by the processor, the information within a user profile. The example method includes transmitting, by the processor, at least some of the information within the user profile to a computerized system that provides output regarding the student user. The example method includes receiving, by the processor, the output regarding the student user. The example method includes storing, by the processor, the output regarding the student user within the user profile of the student user. The example method includes permitting, by the processor, the student user to access and review the output.

An example system includes computing hardware, including a processor, memory, a storage device, and networking hardware. The example system includes an online service implemented by the computing hardware to permit student users to enter information to create user profiles. The example system includes an analysis tool implemented by the computing hardware to generate output regarding the student users from the information and to store the output within the user profiles. The example system includes a searchable database implemented by the computing hardware to permit entities to search for the student users based on at least portions of the user profiles.

### BRIEF DESCRIPTION OF THE SEVERAL VIEWS OF THE DRAWINGS

The drawings referenced herein form a part of the specification. Features shown in the drawing illustrate only some embodiments of the disclosure, and not of all embodiments of the disclosure, unless the detailed description explicitly indicates otherwise, and readers of the specification should not make implications to the contrary.

FIG. 1 is a flowchart of an example computerized method for ranking and rating student users.

FIG. 2 is a flowchart of an example computerized method for providing guidance to the users in multiple forms.

FIG. 3 is a diagram of a system and process flow for an online platform that creates a global database of student users and establishes a science, technology, engineering, and math clearinghouse and/or market exchange.

### DETAILED DESCRIPTION

The following detailed description of exemplary embodiments of the disclosure refers to the accompanying drawings that form a part of the description. The drawings illustrate specific exemplary embodiments in which the disclosure may be practiced. The detailed description, including the drawings, describes these embodiments in sufficient detail to enable those skilled in the art to practice the disclosure. Those skilled in the art may further utilize other embodiments of the disclosure, and make logical, mechanical, and other changes without departing from the spirit or scope of the disclosure.

As noted in the background section, academically oriented students have no vehicle by which comparisons among them can be gleaned at a national or even international level, except for rudimentary standardized testing. This is particularly problematic in the fields of science, technology, engineering and math (STEM); science, Technology, engineering, arts and math (STEAM); and/or science, technology, reading, engineering, arts and math (STREAM). All of these fields in aggregate are referred to herein as STEM.

The academic area of STEM particularly has a large potential market value for candidates as well as colleges and corporations. Many studies have declared a vital shortage of STEM students nationally and globally. 8.7% of college graduates today have the qualifications for 53% of all job openings in technology corporations, for instance. As a result the need exists for a method to create competition, awareness, identification, guidance and recognition in the various STEM fields.

There is indeed a national and global shortage of professionals pursing careers in the fields of STEM. With the number of people retiring who hold jobs in the areas of STEM increasing and the number of students pursuing STEM careers decreasing, a large gap has been created in the STEM workforce. Throughout history innovation and competition have been the driving forces for a prosperous economy. In order to succeed and be competitive in today's global economy, success with STEM education and training has reached a critical point. Government, business and industry, associations and academia are now driving STEM initiatives at the state, national and global levels.

However, as students go through their educational careers several obstacles exist which can limit the amount of opportunities to which the students are exposed. These obstacles can exist in the form of geographic boundaries, school demographics, career awareness, and others. Disclosed herein are techniques that solve these problems.

These techniques disclosed herein include an online computerized system to process related methods enabling the creation of a electronic global data base platform for the rating, ranking, comparing and/or recognition of students in the STEM field. The methods employed include the accumulation, analysis, utilization, and publication of both public and student derived information related to rating, ranking, tracking, identification, and recognition of students. Students are rated and ranked using an algorithm against other students utilizing both public information and student-derived information.

The system provides an online platform for students to be globally recognized, a national and international database of STEM talent, and a platform where students can actively compete with other students to achieve high ratings and have the ability to improve their ratings through the use of an online guidance system. The system has the capability to be utilized as a STEM clearinghouse and/or market exchange that identifies qualified individual students and market participants, and provides a vehicle enabling bidirectional messaging among market participants, multilateral signaling, and preparing longitudinal data analysis for the market place. As such, the problems noted above are ameliorated. The Industry Market Exchange related to STEM provides a platform where; a) middle schools and high schools can learn about the specific industry and opportunities around STEM, b) students can create an e-portfolio geared to a specific industry, c) students can see colleges that specialize in programs related to the industry, d) students can be seen, compared, and tracked by colleges and corporations that are focusing on students interested in a particular industry; e) students can be recruited by colleges specializing in degree or certification programs related to a specific industry; f) corporations can contact colleges via platform that cater to interested students and are pursuing degrees or certifications in the industry; g) industry specific camps, internships, scholarships and job opportunities will all be illustrated on the platform; h) corporations can promote their industry and advertise their company; i) colleges can be evaluated as related to industry specific programs; and j) students will be rated against other students which will result in crating value of a student for colleges and corporations creating liquidity for students in the various markets.

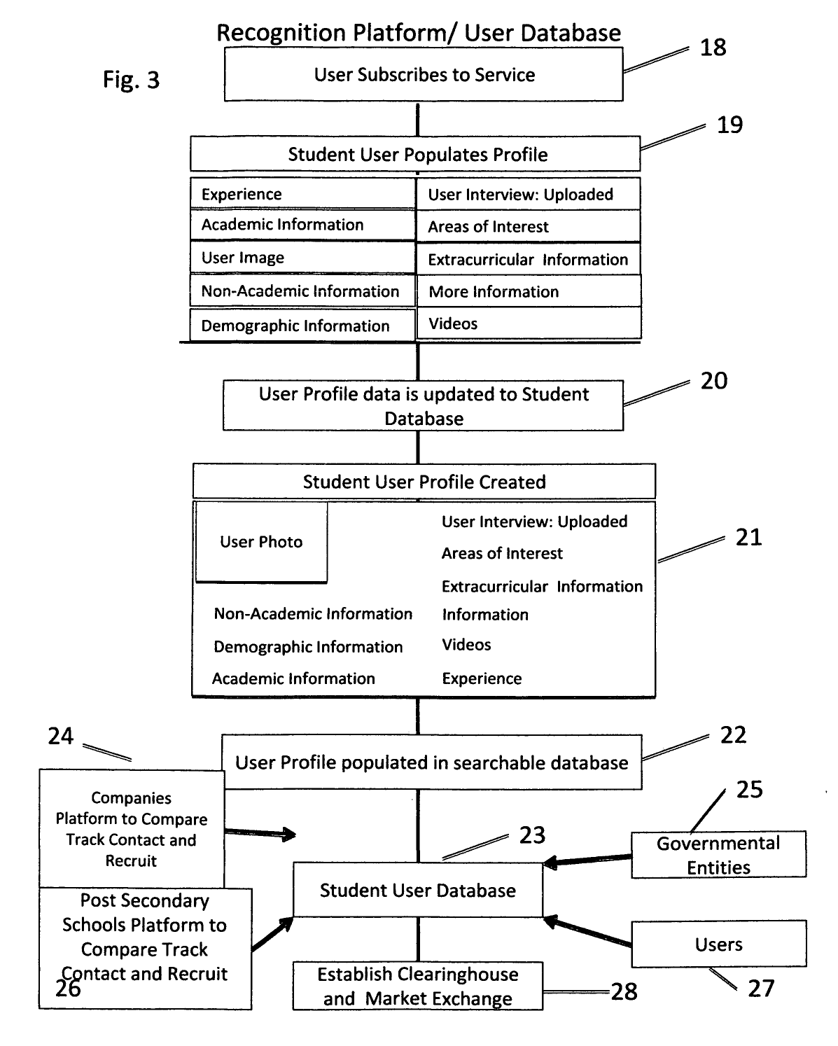

FIG. 3 shows an example system process flow. A platform for an electronic global database 23 provides for the rating, ranking, tracking, guidance, and/or recognition of students in the STEM fields. The system provides an online platform for students to be globally recognized, a national and international database 23 of STEM talent, and a platform where students can actively compete with other students to achieve high ratings 6 and have the ability to improve their rankings 9 (i.e., how each student ranks with respect to his or her ratings in comparison to the ratings of other students) though the use of an online guidance system. The platform is implemented using computing hardware, including processors, memory, non-volatile storage such as hard disk drives, as well as networking hardware. Software runs on the computing hardware.

In FIG. 3, student users subscribe to an online service 18, implemented by the computing hardware, in which they are prompted to complete a series of fields to create user profiles. Examples of such fields include, but are not limited, to academic information, demographic information, activities, achievements, videos, user video interviews, and areas of interests 19. The system provides for the functionality to modify, update and/or remove data at a later date. Once a user has provided the minimum data required to create a user profile the data is saved and updated to create a new user profile 20. The data provided by the user is displayed in a standard format where the user can then modify the profile 21. It is noted that the profile can in some implementations be inclusive of academic and technical achievements, soft skills, earned credentials, and extracurricular and other activities that colleges and corporations can access. A user (i.e., a student) generally has to meet a certain level of proficiency in order to have such entities be able to review their profile 21.

The platform includes an analysis tool implemented by the hardware that generates output regarding the student users from the information that the student users have provided, as discussed in more detail below. This output is stored within the user profiles as well. The student user profile is added to a searchable talent database 22 that is also implemented by the hardware. The searchable student database is used to showcase the users and provide exposure to different entities at the local, state, national and/or global levels 23. Example entities where users can gain exposure include but are not limited to post-secondary schools 26, companies 24, and governmental entities 25. These are entities to which student users of the system are seeking to gain exposure. The student database can be utilized as a clearinghouse or market maker for talent in the various STEM fields.

The platform can in one implementation be utilized as a form of STEM clearinghouse and/or market exchange 28 to identify qualified individual students and market participants, and provide a vehicle enabling bidirectional messaging among market participants and multilateral signaling and longitudinal data analysis for the market place. In this implementation, the clearinghouse or market exchange can include the fields of STREAM. The market exchange 28 thus establishes a liquid market and provides a mechanism for determining the value of STEM talent. In general, it provides an online platform to access and compare such talent; a platform to track and compare subscriber students; a mechanism to exchange and track subscriber data to enable longitudinal studies; and an internal communication platform among subscribers, colleges, corporations, and other entities. The market exchange 28 further establishes a vehicle by which to identify qualified individual students and market participants, and provide a vehicle to permit bidirectional messaging among market participants, multilateral signaling, and the preparation of longitudinal data analyses.

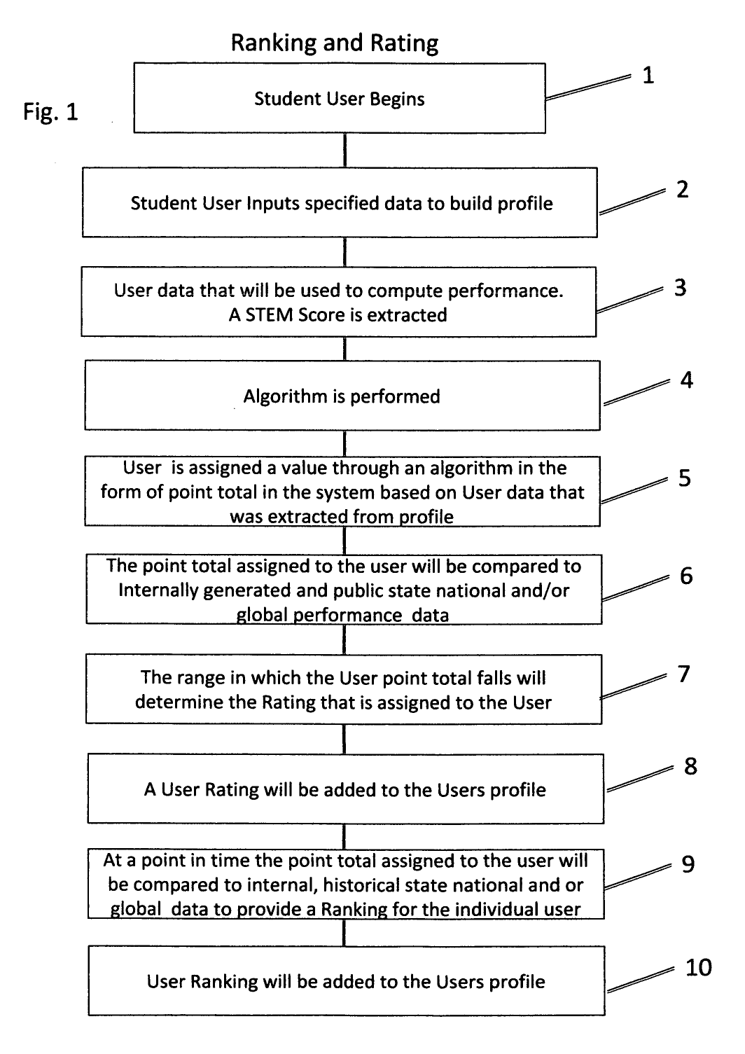

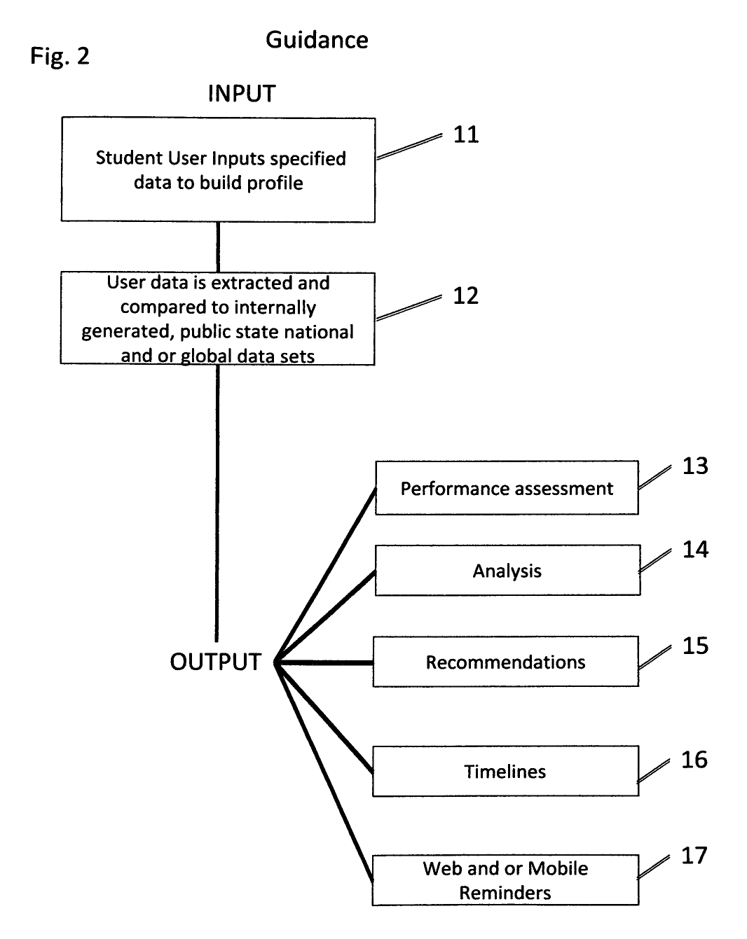

FIG. 2 shows an example computerized method for supplying information back to the student user based on public and proprietary data. The method of FIG. 2, as well as that of FIG. 1 described later in the detailed description, can be performed by a processor of a computing device. The method of FIG. 2 can be implemented as an automated guidance system to provide information to the user in several different forms. Once the user inputs data to create the user profile 11 (that is, information is received from the student user and stored within a user profile), the data is extracted and compared to public and proprietary (i.e., internally generated) datasets 12. The student rating is determined by using a computer algorithm that calculates a standard score based on a number of raw scores comprised of a compilation of all student achievements as well as the student's performance in the fields of Science, Technology, Engineering and Math. The raw scores used can include, but not be limited to, standardized test scores, courses, grades, GPA/QPA, extracurricular activities, multilingual, co-curricular, community service, and various certifications. A rating is calculated by taking each of the student's raw scores (x) a weighted multiplier then added together to generate a standard score that can be compared to normalized data to produce a student rating.

The data is then run through a computerized system, which populates several different outputs for the individual user. Specifically, at least some of the information within the user profile is transmitted to the computerized system, which generates the output, and sends the output back, which is then correspondingly received and stored within the user's user profile. The student user is thus permitted to access and review the output thereafter.

Examples of such outputs include a performance assessment that compares the users data to state, national, and global data, which can then be correlated into a chart or similar format 13. Other output can include a user analysis 14. The analysis includes key performance indicators that the database identifies for the student user. Embodiments of the invention are not limited to any particular manner by which such indicators are generated. These key performance indicators are used to provide the student with recommendations 15 on how to improve their scores or become more involved, in a textual or graphical format. Examples in this respect include but are not limited to enrolling into a test preparation course, and increasing the number of extracurricular activities the user is involved in.

User data is also used to provide a timeline 16 feature that can be utilized by the user. The timeline provides information back to the student user based on his or her current point in the educational lifecycle. Examples of information that can be provided from the platform include but are not limited to academic related information such as testing dates based on public information, financial aid information, and/or educational guidance. All information from the online platform can be utilized through the web interface or through mobile devices. Users are able to receive updates, reminders or other information pertaining to user data, events and/or other related information through web or mobile devices 17.

FIG. 1 shows an example computerized method for assigning a ranking and/or rating to a student user based on data sets. The ranking and/or rating is created through the use of an algorithm that extracts user data and computes the information by comparing data to public datasets based on other students performance. In this respect, one implementation can be limited to only public data. Once the user subscribes to the service 1 the student user inputs data 2 into specified data fields to build user profile. A subset of user data is extracted 3 from the user profile that is then used to compute a performance score for the individual user.

An algorithm 4 is performed with the extracted user data. The raw scores used can include, but not be limited to, standardized test scores, courses, grades, GPA/QPA, extracurricular activities, multilingual, co-curricular, community service, and various certifications. A rating is calculated by taking each of the student's raw scores (x) a weighted multiplier then added together to generate a standard score that can be compared to normalized data to produce a student rating. The algorithm is used to produce a point value or score based on performance indicators within the data provided by the user. Embodiments of the invention are not limited to any particular algorithm, and the algorithm itself is beyond the scope of the present disclosure. Once the algorithm has been completed a point total is assessed to each of the components of the algorithm and a score is calculated 5. For instance, a score is said to be generated for the student user based on the performance indicators provided by the user. The score can be generated by generating a sub-score for each performance indicator. The sub-scores for the performance indicators are totaled to realize the score in one implementation.

The calculated score is then compared to public data for each of the criterion at the state, national and/or global levels 6. It is further noted that the calculated score can be compared to internally generated data. The raw scores used can include, but not be limited to, standardized test scores, courses, grades, GPA/QPA, extracurricular activities, multilingual, co-curricular, community service, and various certifications. A rating is calculated by taking each of the student's raw scores (x) a weighted multiplier then added together to generate a standard score that can be compared to normalized data to produce a student rating. An example of public data can consist of state and national SAT scores (i.e., standardized test data). The range in which the user's score falls determines the rating value assigned 7. A user may not be limited to only one rating, however. User ratings are shown graphically or textually on the user profile 8; that is, more generally, the user ratings are output.

At a defined point in time the user score determined by the algorithm is compared to other students at the state, national, and global level. The comparison can be achieved in relation to such data that is internally generated. The raw scores used can include, but not be limited to, standardized test scores, courses, grades, GPA/QPA, extracurricular activities, multilingual, co-curricular, community service, and various certifications. A rating is calculated by taking each of the student's raw scores (x) a weighted multiplier then added together to generate a standard score that can be compared to normalized data to produce a student rating. This comparison is then used to assign a ranking to the user based on provided data 9. The ranking of the user is added to the users profile if the users score falls within a certain range 10. That is, the ranking is output. It is noted that, therefore, a student is rated pursuant to parts 7 and 8 of FIG. 1, and a score and ranking of a student is accomplished pursuant to parts 3-6 and 9-10 of FIG. 1.

By utilizing the techniques disclosed herein, both student participants and the entities with which they interact can be advantaged. The students are able to be compared internationally or nationally to other students, and learn how to receive better rankings in this respect. Entities, like corporations, academic institutions, governmental organizations, and so on, are able to locate and assess students having desired skills.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. As such and therefore, it is manifestly intended that this invention be limited only by the claims and equivalents thereof.

We claim:

1. A method comprising:
receiving, by a processor, data regarding a student user, including a plurality of performance indicators;
generating, by the processor, a score for the student user based on the performance indicators;
comparing, by the processor, the score for the student user to publicly available data;
determining, by the processor, a rating value for the student user based on the score for the student user as compared to the public data; and
outputting, by the processor, the rating value.

2. The method of claim 1, further comprising, after determining the rating value:
comparing, by the processor, the rating value for the student user to rating values of a plurality of other student users;
determining, by the processor, a ranking of the student user based on the rating value for the student user as compared to the rating values of the other student users; and
outputting, by the processor, the ranking.

3. The method of claim 2, wherein outputting the rank comprises:
storing the ranking within a user profile for the student user.

4. The method of claim 1, further comprising:
extracting, by the processor, the performance indicators from the data regarding the student user.

5. The method of claim 1, wherein receiving the data regarding the student user comprises:
receiving the data as entered by the student user within a user profile for the student user.

6. The method of claim 1, wherein generating the score for the student user comprises:
generating a sub-score for the student user for each performance indicators; and
adding the sub-scores for the performance indicators to yield the score for the student user.

7. The method of claim 1, wherein the public data comprises publicly available standardized test data.

8. A method comprising:
receiving, by a processor, information from a student user;
storing, by the processor, the information within a user profile;
transmitting, by the processor, at least some of the information within the user profile to a computerized system that provides output regarding the student user;
receiving, by the processor, the output regarding the student user;
storing, by the processor, the output regarding the student user within the user profile of the student user; and
permitting, by the processor, the student user to access and review the output.

9. The method of claim 8, wherein the output regarding the student user comprises:
a performance assessment of the student user.

10. The method of claim 8, wherein the output regarding the student user comprises:
an analysis of key performance indicators for the student user.

11. The method of claim 8, wherein the output regarding the student user comprises:
one or more recommendations for the student user to increase a ranking thereof.

12. The method of claim 8, wherein the output regarding the student user comprises:
timing deadlines for the student user regarding academic-related information.

13. A system comprising:
computing hardware, including a processor, memory, a storage device, and networking hardware;
an online service implemented by the computing hardware to permit a plurality of student users to enter information to create user profiles;
an analysis tool implemented by the computing hardware to generate output regarding the student users from the information and to store the output within the user profiles; and
a searchable database implemented by the computing hardware to permit entities to search for the student users based on at least portions of the user profiles.

14. The system of claim 13, wherein the output comprises ratings of the student users within a plurality of categories.

15. The system of claim 14, wherein the output comprises rankings of the student users, the rankings establishing an ordering of the student users based on the ratings thereof.

16. The system of claim 13, wherein the student users are science, technology, engineering, and math (STEM) students.
